(19) United States
(12) Patent Application Publication
(10) Pub. No.: US 2015/0064680 A1
(43) Pub. Date: Mar. 5, 2015

(54) METHOD AND SYSTEM FOR ADJUSTING THE DIFFICULTY DEGREE OF A QUESTION BANK BASED ON INTERNET SAMPLING

(71) Applicant: UMeWorld, Causeway Bay (HK)

(72) Inventor: Man Ching Michael LEE, Fanling (HK)

(73) Assignee: UMeWorld, Causeway Bay (HK)

(21) Appl. No.: 14/012,556

(22) Filed: Aug. 28, 2013

(51) Int. Cl. G09B 7/00

(52) U.S. Cl. CPC G09B 7/00
USPC 434/350; 434/362; 434/353

(57) ABSTRACT

A system and method of providing a test may include generating, by a processor, a question having a difficulty coefficient. The processor may receive input from a participant answering the question. The processor may further measure a time for the participant to complete the question. The processor may determine whether or not to include the participant's input in adjusting the difficulty coefficient of the question, wherein said determination is based on the measured time.

### FIELD OF THE PRESENT INVENTION

The present invention relates to a method of teaching and adjusting the degree of difficulty of test questions based on a sampling of test-takers.

### BACKGROUND

A significant part of teaching or instruction may include providing tests or exams to assess the skills of a student. Providing different kinds of exercises at mixed or different difficulty levels for students and evaluating the quality of the test questions may be time consuming for teachers. For students, being given the same kinds of exercises by time-strapped teachers may not provide a quality educational experience and may not motivate them to learn different ways of thinking or learn all aspects of a test subject.

More testing may be done online to save time for the teacher and the student. The student or teacher can quickly and easily submit answers online for evaluation, receive results, and retrieve more questions if desired. The online environment may also provide a larger variety of test questions from different academic or testing publishers. The variety of test questions may include various difficulty levels or ratings according to the subject and grade level of the student. However, these difficulty levels or ratings may be based on subjective factors that are difficult to ascertain from a publisher's standpoint. Further, students may not always answer each question diligently, which may interfere with determining the difficulty of a question.

### SUMMARY

A method or system may determine or adjust the difficulty of a test question while taking into account the student's diligence. A method and system of providing a test may include generating, by a processor, a question having a difficulty coefficient. The processor may receive input from a participant answering the question. The processor may further measure a time for the participant to complete the question. The processor may determine whether or not to include the participant's input in adjusting the difficulty coefficient of the question, wherein said determination is based on the measured time.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a diagram of a testing system, according to embodiments of the invention.

FIG. 2 is a logic flowchart of a method for gathering participant samples for a plurality of questions, according to an embodiment of the invention.

FIG. 3 is a diagram of a software architecture implementing a testing system, according to embodiments of the invention.

FIG. 4 is an illustration of a user interface for administering exams, according to embodiments of the invention.

FIG. 5 is a flowchart of a method for adjusting a difficulty coefficient, according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention may provide a system or method for adjusting, modifying, or determining the difficulty rating of a test question. Tests may be provided through retrieving or accessing a set of questions stored on a computer, such as a server or a cloud computing service. Participants of a test, such as students in school or self-learners, may take a test on or via a computer or computing device, such as a smart phone or a tablet, for example. A test may be any group of questions that evaluates the skills or knowledge of test participants. Each test may be on topic or subject, or may include several topics or subjects. Subjects may include for example math, science, language, foreign languages, or history, for example. The questions may have different types, such as for example true/false, multiple choice, fill in the blank, essay questions, or other types or formats.

Participants of a test, or administrators of a test such as teachers, proctors, or standardized testing agencies, may desire that tests include questions of varying difficulty to best asses the range of skills or knowledge of a participant. However, determining the difficulty of a test may depend on subjective factors that may be difficult to measure, such as the teaching skill of a teacher, quality of textbooks, or depth of thinking required for a subject or topic. Further, accurately determining the difficulty of a test or question may require the assumption that all participants are answering the question diligently. However, for example, participants may actually be in a rush to finish a test or may not be concentrating on answering the question. Embodiments of the invention may be able to detect or determine, based on the user behavior of participants taking a test, which questions are being diligently answered by which participants. Participants exhibiting proper test-taking behavior may be included in the sample determining the difficulty of a question, and participants indicating a lack of diligence in answering questions may be removed from a sample in determining difficulty of a question.

Embodiments of the invention may determine proper user behavior of participants taking a test by, for example, measuring or determining the time for test participants to answer a question. If participants fail to take an appropriate amount of time to answer a question, then participants may be deemed as not exhibiting proper user behavior for a test-taker. For each question, based on the type, length, and difficulty of the question, a threshold or reference time may be determined. The threshold or reference time may represent the fastest possible time that an ideal participant would complete (e.g. provide an answer, correct or incorrect) a question. If a participant completes a question in an amount of time less than the threshold or reference time, then the participant is more likely to have answered carelessly or desired to skip the question. The threshold time may be longer for more complex types of questions, such as essay questions, than for simpler types of questions, such as true/false questions. The threshold time may also be longer for more complex topics, such as calculus, compared to easier simpler topics, such as arithmetic.

In a theoretical timeline for a participant answering a question, the participant may perform three consecutive tasks: reading the question, thinking about the answer, and finally, answering the question. The three consecutive tasks may overlap in time. For example, a participant may begin thinking about the answer in the middle of reading the question, or the participant may begin answering the question (e.g., inputting the answer into a computer) before thinking about the full answer. The threshold or reference time representing an ideal answering time may take into account the timeline of these three tasks and their overlaps.

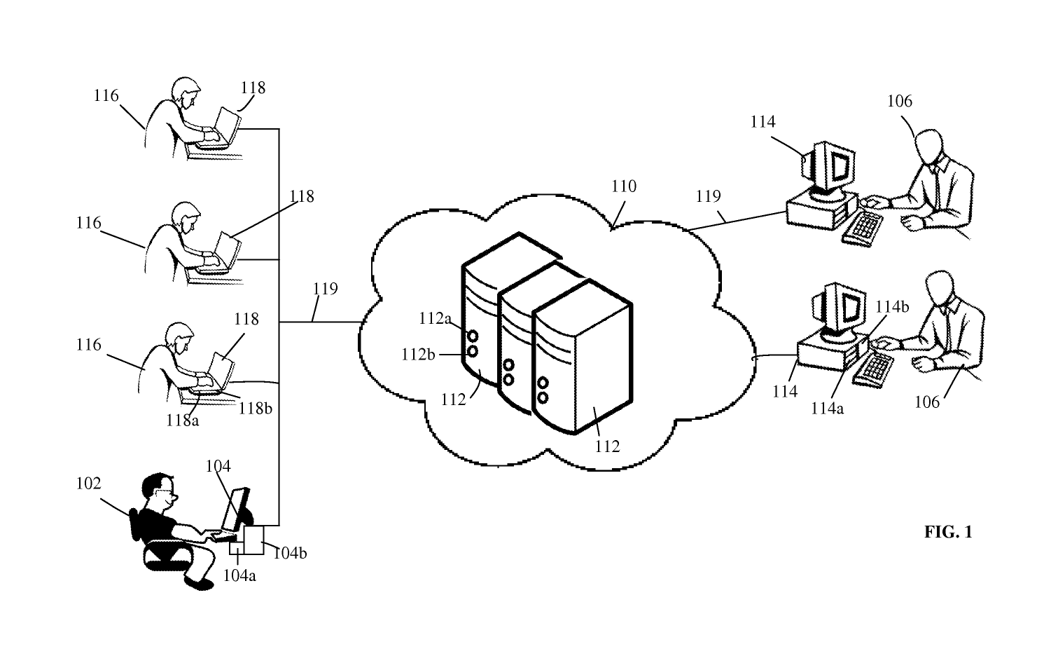

FIG. 1 is a diagram of a testing system, according to embodiments of the invention. Publishers 108 of testing or question material may upload content to a server or cloud computing system 110. The server or cloud computing system 110 may be a server connected to the Internet, for example. The cloud computing system 110 may include a network of computer servers 112, each of which may include memory 112a and a processor 112b. Publishers 106 may use their own computers 114 or devices with memory 114a and a processor 114b to upload content to cloud computing system 110. An instructor or administrator 102 of a test may input testing parameters into a computer 104 having a display or user interface 106 and memory 104a and a processor 104b. The testing parameters may describe characteristics of desired questions for a test to administer to students 116. The tests may be distributed on student computers or devices 118, which may each include memory 118a and a processor 118b. The administrator or teacher 102 and the students 116 may be part of one school or organization, and each of their devices 118, 104 may be connected via a school network, such as an intranet or the Internet 119, for example. The school may also be an online course, and the administrator 102 and students 116 may be connected through their respective devices through the Internet.

Parameters input into the teacher's 102 device 104 may describe characteristics of a set of questions including number of desired questions, subject, grade level, and average difficulty, for example. Teacher's device 104 may be connected to or coupled with servers or cloud computing service 110 by for example a connection through the Internet 119. Parameters input by the teacher or administrator 102 may be transmitted to the cloud computing service 110, and cloud computing service 110 may generate, create, or produce a set of questions having the characteristics described by the received input. The cloud computing service 110 may store in memory 112a a table or database of questions uploaded from various publishers 106. The table or database may include the questions' content along with information such as the correct answer, an explanation of the answer, a difficulty coefficient or rating, a subject, a grade level, a length of the question, a length of the correct answer, a threshold time, and/or other characteristics or information. Upon receiving the input parameters, cloud computing service 110 may generate a set of questions by determining or selecting which questions in the database or table match the input parameters and include the questions in a test set. The test set may be transmitted to each of the students 116 via their student devices 118.

According to some embodiments, students 116 input their answers to the test through a user interface on device 118. The user interface may be in the form of a standalone application or a webpage, for example. For each question answered by a student 116, processor 118b may measure the student's 116 completion time through a timing application or program. The start of measuring the student's 116 completion time may begin for example once the student 116 begins reading a test question, or when a test question appears to the student 116. The end of the student's 116 completion time for a question may occur for example once the student has chosen an answer, or when the student has moved onto the next question. On a webpage, the timing application may be a Java applet, or a timing application may be implemented via Hypertext Markup Language (HTML), for example, embedded in the webpage. Other timing methods may be used. Each of the answers input into student device 118 along with the student 116 or participant's completion time for each question may be stored temporarily in memory 118a on student device 118. Alternatively, each student's answer and completion time received by student devices 118 may be transmitted to the cloud computing service 110 as the student 116 answers each question. Once a testing session is complete, cloud computing service 110 may receive an answer file, including student answers and completion time for each question, from each student 116. Cloud computing service 110 may determine whether or not to include students' 116 answers as samples in determining or adjusting the difficulty of a question. Each question may have a pre-defined difficulty rating or coefficient, for example by being assigned an initial rating, or by a previous calculation based on other samples. For example, if a difficulty coefficient for a question is unknown, it may automatically or by default be assigned as 0.5 or 0.7. (Ranges of difficulty ratings other than 0-1 may be used.) The determination or decision whether or not to include students' 116 input or answer may be based on comparing the threshold or reference time of the question (e.g., stored in servers' memory 112a) with each student's 116 completion time. The process of sampling students' 116 answers and modifying, adjusting or re-calculating the difficulty rating of each question may occur asynchronously with receiving answer files from students, or during a network's off-peak times, for example.

According to some embodiments, an administrator 102 of a test and a student 116 may act as one participant in the test. For example, in a self-taught online course, the participants or students 116 may choose to administer their own set of questions according to their needs.

Devices 104, 118, 112, and 114 may each include one or more controller(s) or processor(s) 104b, 118b, 112b, and 114b, respectively, for executing operations and one or more memory unit(s) 104a, 118a, 112a, and 114a, respectively, for storing data and/or instructions (e.g., software) executable by a processor. Processor(s) 104b, 118b, 112b, and 114b may include, for example, a central processing unit (CPU), a digital signal processor (DSP), a microprocessor, a controller, a chip, a microchip, an integrated circuit (IC), or any other suitable multi-purpose or specific processor or controller. Memory unit(s), 118a, 112a, and 114a may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units. Processors 104b, 118b, 112b, and 114b may be general purpose processors configured to perform embodiments of the invention by for example executing code or software stored in memory, or may be other processors, e.g. dedicated processors. In general, a processor may refer to individual or standalone processors as present in one device, such as a computer, or may refer to more than one processor which may be coupled together to share processing tasks, such as the division of tasks between a processor on a computer and a processor on a server. Other configurations may be used.

The following examples illustrate ways in which a threshold time and difficulty coefficient or rating is determined, adjusted or modified for each question. In some embodiments, a difficulty coefficient or rating d for a test question may be calculated by the following formula:

d=1−A/T (1)

where A is a number of participants who answered a question correctly, and T is a total number of participants included in the sample (for example, participants who answered the question in a time, or period of time or duration, greater than a threshold time for a question). Other or different difficulty coefficients or ratings may be used, and other or different formulas may be used. The difficulty coefficient or rating may be indicative of the difficulty a student or sample students may have in answering the question, and may for example be related to the number of a certain population of students answer the question correctly or incorrectly.

As mentioned previously, a threshold or reference time for each question may be based on characteristics of the question, such as subject, type, difficulty rating, length of the question and length of the answer, or other factors. Types of questions t, for example, may be enumerated by the following legend: 1 may signify a true/false question, 2 may signify a multiple choice question, 3 may signify a fill-in-the-blank question, 4 may signify a reading comprehension or long form question. Subjects s may also be enumerated by a legend. The threshold or reference time f for each question may be calculated or stored in a database, according to for example the following formula:

$$f = \frac{{w}_{1}}{{v}_{1}} + ( \begin{matrix}s \\ t\end{matrix} ) d {log}_{3} x + \frac{{w}_{2}}{{v}_{2}} \qquad ( 2 )$$

where w₁ is number of words in a question, v₁ is a reading speed of a participant, w₂ is a number of words in the correct answer, v₂ is a speed to answer a question (e.g., typing speed, pointing-device clicking speed, or touchscreen operation speed), x is a time (e.g., a period of time or duration) for a participant's thinking, where x may be, for example anywhere from 1 to 27 seconds. x may be controlled or determined by an administrator or student, depending on the student's subjective ability or other factors. Other variables and time ranges may be used, and other or different formulas may be used.

For illustration, a math true/false question with a subject legend s of 5 may have the following example characteristics: difficulty rating d of 0.5, w₁=40 words, v₁=400 words/minute, t=1, w₂=1 word, v₂=126 words. According to equation (2), threshold time may be calculated as follows, for x having the minimum participant thinking time of 1 second:

$$f = \frac{40}{400} + ( \begin{matrix}5 \\ 1\end{matrix} ) 0.5 \cdot {log}_{3} 1 + \frac{1}{126} \approx 6.48 seconds \qquad ( 3 )$$

For a maximum participant thinking time of 27 seconds, the threshold time may be calculated as:

$$f = \frac{40}{400} + ( \begin{matrix}5 \\ 1\end{matrix} ) 0.5 \cdot {log}_{3} 27 + \frac{1}{126} \approx 13.98 seconds \qquad ( 4 )$$

In another illustration, a math multiple choice question with t=2, and s=5 may include the following parameters difficulty rating d of 0.5, w₁=40 words, v₁=400 words/minute, t=1, w₂=2, 3, 4, 5, or 6 (depending on how many answer choices are presented, for example), v₂=126 words. According to equation (2), a minimum threshold time may be calculated as follows:

$$f = \frac{40}{400} + ( \begin{matrix}5 \\ 2\end{matrix} ) 0.5 \cdot {log}_{3} 1 + \frac{2}{126} \approx 6.95 seconds \qquad ( 5 )$$

A maximum threshold time, having 6 answers to choose from and a maximum participant thinking time of 27 seconds, may be calculated as:

$$f = \frac{40}{400} + ( \begin{matrix}5 \\ 2\end{matrix} ) 0.5 \cdot {log}_{3} 27 + \frac{6}{126} \approx 23.86 seconds \qquad ( 6 )$$

Another example of a formula for calculating or determining a threshold time may be the following:

$$f = ( \begin{matrix}s \\ t\end{matrix} ) \frac{A}{T} [ \frac{w}{400} + ( 1 - {lim}_{\frac{A}{T} \to ∞} {x}^{\frac{A}{T }} ) {\sum }_{x = 0}^{n} ( \begin{matrix}n \\ x\end{matrix} ) {u}^{n - x} {v}^{x} ] \qquad ( 7 )$$

where s is a number representing a subject, t is a type of question, A is an average score for all participants, T is a total number of participants, w is a number of words in an answer, v is a speed to answer a question (e.g., typing speed, pointing-device clicking speed, or touchscreen operation speed), u is a time to read the question, n is a number of words in the answer. Other variables and time ranges may be used, and other or different formulas may be used.

Other parameters and characteristics of questions and participant aptitude may be included in calculating or determining a threshold time for each question. Other or different formulas may be used, and other or different parameters and time ranges than those provided herein may be used.

In another illustration, for example, a question may have a threshold time as calculated in equation (5). A cloud computing service may gather all participant results for the question and determine that 14 out of 20 participants taking a test answered the question with a completion time greater than the threshold time of 6.95 seconds. The server or cloud computing service may only include 14 of the participants' answers in recalculating or adjusting the difficulty coefficient. The answers of the 6 participants whose completion time is less than 6.95 seconds may be discarded or discounted. If, of the 14 participants having a completion time greater than 6.95, 4 participants answered correctly, then the difficulty coefficient may be modified or adjusted as follows, according to equation (1):

$$d = 1 - \frac{4}{14} \approx 0.71 \qquad ( 8 )$$

Other variables may be used, and other or different formulas may be used.

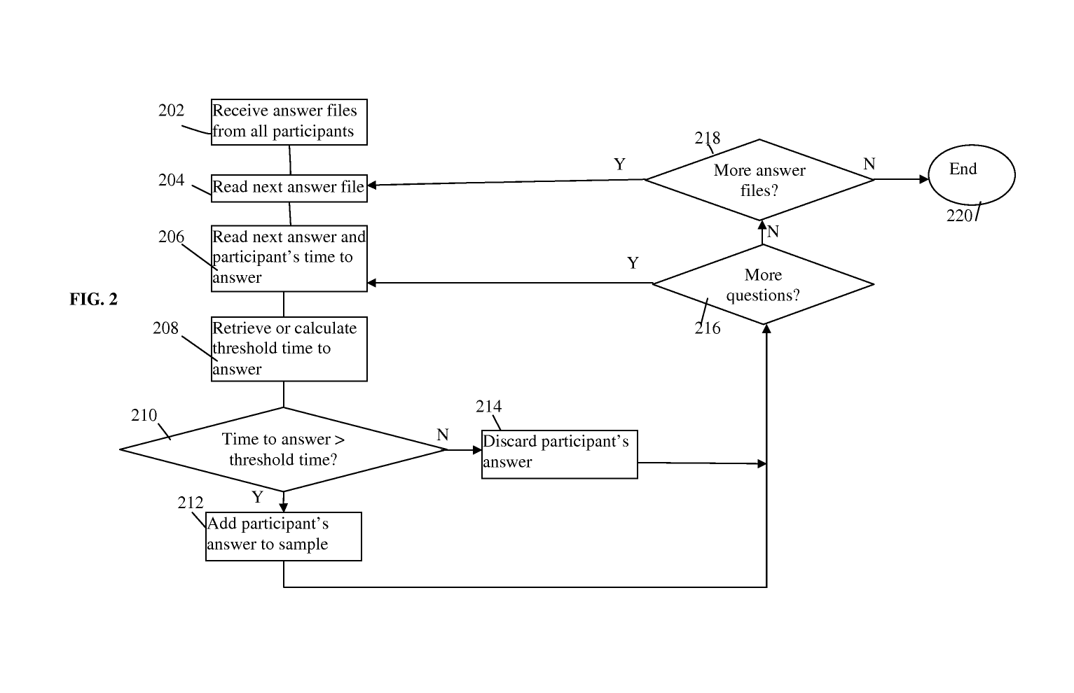

FIG. 2 is a logic flowchart of a method for gathering participant samples for a plurality of questions, according to an embodiment of the invention. When a testing session has completed (or beforehand), a server or cloud computing service may receive, in operation 202, answer files from each participant of a test. Answer files may include answers input by participants into a device along with the completion time of each question. In operation 204, the server may begin reading the next or first answer file. For each file, the server may read or receive each question and the participant's time to answer the question in operation 206. Based on the question's characteristics, the server may calculate a threshold time for the question in operation 208. Alternatively, the server may retrieve the question's threshold time in a lookup table stored in memory. In operation 210, the server may compare the participant's completion time for the question with the question's threshold question determined or retrieved in operation 208. If the participant's time to answer the question is greater (or greater than or equal to) than the threshold time, in operation 212, the participant's answer is added to the sample to adjust or determine the question's difficulty coefficient. The total number of participants for the question may be incremented by one, for example. If the participant answered correctly, the number of correct participants may be incremented by one. Other operations may occur to include the participant's answer into the sample. If the participant's time to answer the question is not greater than the threshold time, the participant's answer is discarded or discounted in operation 214. The server may then determine, in operation 216, whether there are more questions to evaluate in the answer file. If so, the server will read the next answer in the answer file and repeat operations 206 to 214. If no more questions may be read in an answer file, the server may determine, in operation 218, whether more answer files from other participants may be evaluated. If so, operations 204 to 216 may be repeated or iterated. If not, the routine for gathering participant samples may end at operation 220. The adjusting of the difficulty coefficient for each question, based on the gathered participant samples, may be performed at a convenient time for the server or network.

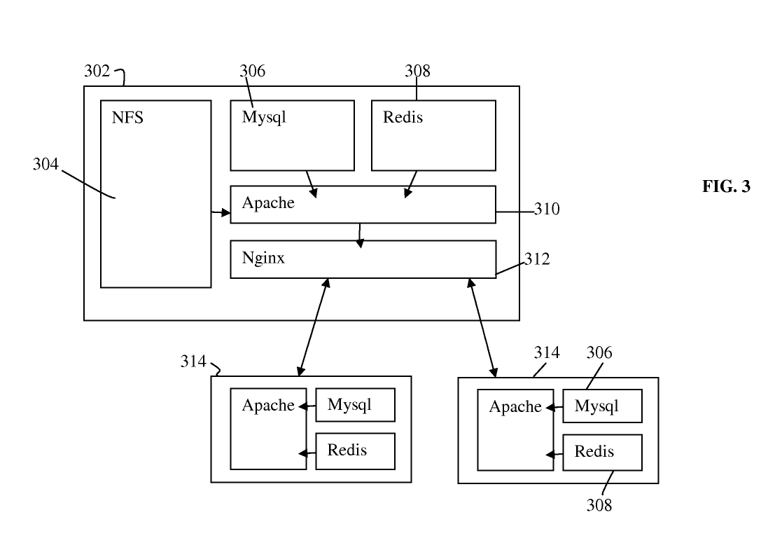

FIG. 3 is a diagram of a software architecture implementing a testing system, according to embodiments of the invention. Other or different architectures, and different specific components, may be used. A network of servers 302, or a cloud computing system residing on the Internet, for example, may implement a Network File System (NFS) 304, which may be a distributed file system. The NFS 304 may store a bank or collection of questions uploaded by different publishers, for example. The NFS 304 may allow school networks connected to the network of server 302 to access question bank files as local files, even though they may be distributed across several computers or servers. The servers 302 may implement a relational database, such as Mysql 306 and a networked key-value data store, such as Redis 308. The Mysql 306 relational database may store data describing characteristics of each question in the question bank, such as the question's length, and its answer's length. The Redis 308 key-value data store may store each question's difficulty coefficient, which may be more easily retrieved and changed in Redis than the questions' characteristics stored in Mysql 306. An Apache web server 310 may gather the information from Mysql 306, NFS 304, and Redis 308 and deliver it to an Nginx server 312, which may be a proxy server for delivering dynamic HTTP (Hypertext Transfer Protocol) content. The Nginx server 312 may use an asynchronous approach in delivering questions from a question bank to school networks 314 and receiving answer files from school networks 314 to adjust the difficulty degree of questions. Each school network 314, which may involve a network of administrator and participant devices, may also include an Apache web server 310, a Mysql 306 relational database, and a Redis 308 key-value data store. School networks 314 may also use their own networks to adjust difficulty coefficients according to their own participant samples, and thus may also store their own databases of question characteristics.

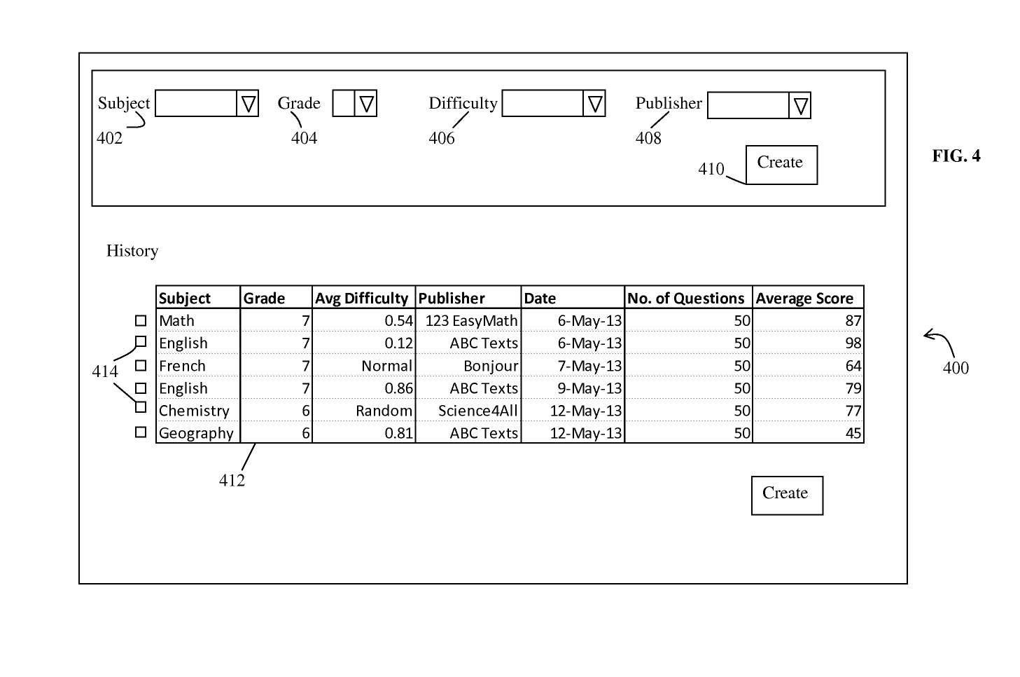

FIG. 4 is an illustration of a user interface 400 for administering exams, according to embodiments of the invention. Other or different interfaces may be used. An administrator of a test may input desired characteristics of a set of questions, such as subject 402, grade 404, difficulty 406, or publisher 408, for example. Each of the characteristics may be chosen through a drop-down menu or other input method. The difficulty 406 may be set at a constant difficulty, as an average or as a random or normal distribution. Other desired characteristics may be available for an administrator's input. The administrator may click (e.g., indicate using a pointing device such as a mouse, or a touchscreen on a “Create” button 410 to generate one or more questions. Administrators may also be able to view a history table 412 of tests they have distributed or administered to students. If the administrators or teachers wish, they may repeat characteristics of questions that they have administered in the past, by checking the desired radio button 414.

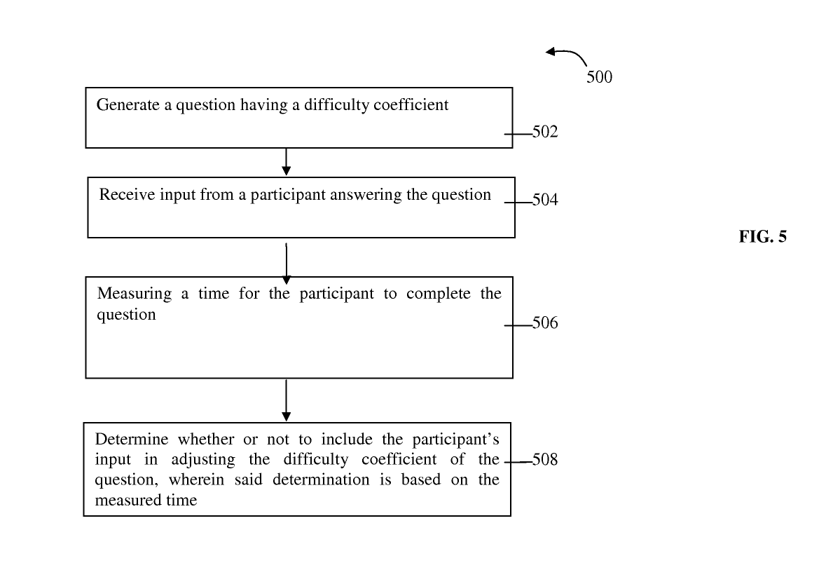

FIG. 5 is a flowchart of a method 500 for adjusting a difficulty coefficient, according to embodiments of the invention. While one example of an architecture to carry out an embodiment method is shown above, other or different architectures may be used. In operation 502, a server or a computer connected to a server may generate or select (e.g., choose from a bank of questions) a question. The question may have a difficulty coefficient which rates or signifies the difficulty of a test question based on, for example, the number of a sample participants who correctly answer the question. In operation 504, the server or computer may receive input from a participant answer the question. In operation 506, a processor that is part of a device that the participant is using may measure a time (e.g., a period of time or duration) for the participant to answer or complete the question. For example, the time to answer or complete the question may be the time duration between when the question is first presented to the participant and when an answer—correct or incorrect—is input into the user's computer or terminal. Other measures of time to complete or time to answer may be used. In operation 508, the server, or a processor in the server, may determine whether or not to include the participant's input in adjusting the difficulty coefficient of the question. The determination may be based on the participant's completion time of the question. The participant's completion time may be compared with a threshold or reference time relevant to the question. The threshold or reference time may be based on characteristics of the question, such as subject, type of question, length of question, length of answer, or other factors. Other or different operations may be used.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus certain embodiments may be combinations of features of multiple embodiments.

What is claimed is:

1. A method of providing a test, comprising:
generating, by a processor, a question having a difficulty coefficient;
receiving input, by the processor, from a participant answering the question;
measuring, by the processor, a time for the participant to complete the question; and
determining whether or not to include the participant's input in adjusting the difficulty coefficient of the question, wherein said determination is based on the measured time.

2. The method of claim 1, comprising comparing the measured time to a threshold time for the question and determining to include the participant's input in adjusting the difficulty coefficient if the measured time is greater than the threshold time.

3. The method of claim 2, comprising calculating the threshold time based on characteristics of the question, said characteristics including the type, length, and difficulty of the question.

4. The method of claim 2, comprising adjusting the difficulty coefficient of the question based on whether the participant answered the question correctly.

5. The method of claim 1, comprising adjusting the difficulty coefficient of the question based on a total number of participants that answered the question and a number of the total participants that answered the question correctly.

6. The method of claim 1, comprising displaying results of the question to the participant, including a correct answer and an explanation of the correct answer.

7. The method of claim 1, comprising receiving input describing a number of questions, subjects, and difficulty and generating a plurality of questions based on the received input.

8. A testing system, comprising:
a computer comprising a memory and a processor, the processor configured to:
generate a question having a difficulty coefficient;
receive input from a participant answering the question;
measure a time for the participant to complete the question; and
determine whether or not to include the participant's input in adjusting the difficulty coefficient of the question, wherein said determination is based on the measured time.

9. The system of claim 8, wherein the processor is configured to compare the measured time to a calculated threshold time for the question and determining to include the participant's input in adjusting the difficulty coefficient if the measured time is greater than the predetermined threshold time.

10. The system of claim 9, wherein the calculated threshold time is based on characteristics of the question, said characteristics including the type, length, and difficulty of the question.

11. The system of claim 10, wherein the processor is configured to adjust the difficulty coefficient of the question based on whether the participant answered the question correctly.

12. The system of claim 8, wherein the processor is configured to adjust the difficulty coefficient of the question based on a total number of participants that answered the question and a number of the total participants that answered the question correctly.

13. The system of claim 8, wherein the processor is configured to display results of the question to the participant, including a correct answer and an explanation of the correct answer.

14. The system of claim 8 wherein the processor is configured to receive input describing a number of questions, subjects, and difficulty and generate a plurality of questions based on the received input.

15. The system of claim 1, wherein the processor is configured to store a plurality of questions, each question having a corresponding type, length, and difficulty coefficient.

16. A testing apparatus, comprising:
a computer comprising a memory and a processor; and
a server coupled to the computer through a network;
wherein the processor is to:
receive input describing characteristics of desired questions;
receive, from the server, a plurality of questions having the characteristics described by the received input;
receive answers to the plurality of questions from a participant;
for each of the plurality of questions, determine a completion time describing the participant's time to complete the question; and
transmit the received answers and the completion time to the server; and
wherein the server is to:
for each of the plurality of questions, compare the completion time to a reference time corresponding to each question; and
for each of the plurality of questions, if the completion time is greater than the reference time, modify the difficulty rating of the question based on the participant's answer to the question.

17. The apparatus of claim 16, wherein the server is to receive, for each question, an answer and a corresponding completion time from a plurality of participants.

18. The apparatus of claim 17, wherein the server is to, for each of the plurality of questions and for each of the participants, modify the difficulty rating of the question based on the participant's answer and corresponding completion time if the participant's completion time is greater than a reference time for each question.

19. The apparatus of claim 16, wherein the reference time for each question is based on a type, length, and the difficulty rating of the question.

20. The apparatus of claim 17, wherein the difficulty rating of the question is based on a total number of the participants.
